(19) United States
(12) Patent Application Publication
(10) Pub. No.: US 2023/0373108 A1
(43) Pub. Date: Nov. 23, 2023

(54) JOINT MECHANISM

(71) Applicant: TOYOTA JIDOSHA KABUSHIKI KAISHA, Toyota-shi (JP)

(72) Inventor: Kazutoshi NISHII, Toyota-shi (JP)

(73) Assignee: TOYOTA JIDOSHA KABUSHIKI KAISHA, Toyota-shi (JP)

(21) Appl. No.: 18/176,681

(22) Filed: Mar. 1, 2023

(30) Foreign Application Priority Data
May 19, 2022 (JP) 2022-082499

(51) Int. Cl. B25J 17/02; B25J 9/10

(52) U.S. Cl. CPC B25J 17/0283; B25J 17/0266; B25J 9/104

(57) ABSTRACT

A joint mechanism includes: a first link and a second link; a joint portion that rotatably connects the first link and the second link; a pulley provided on the joint portion; and a linear member that extends from one end on the first link side to the other end on the second link side, the linear member being wound around a pulley halfway through. The rotation center of the joint portion is offset with respect to the center of the pulley such that a change in a path length of the linear member when the joint portion is extended and bent is reduced.

### CROSS-REFERENCE TO RELATED APPLICATION

This application claims priority to Japanese Patent Application No. 2022-082499 filed on May 19, 2022, incorporated herein by reference in its entirety.

### BACKGROUND

### 1. Technical Field

The present disclosure relates to a joint mechanism for a robot and the like.

### 2. Description of Related Art

A joint mechanism is known that includes a first link and a second link, a joint portion that rotatably connects the first link and the second link, a pulley provided on the joint portion, and a linear member that extends from one end on the first link side to the other end on the second link side, the linear member being wound around the pulley halfway through (see, for example, Japanese Patent No. 6545768 (JP 6545768 B)).

### SUMMARY

However, in the above joint mechanism, the path length of the linear member may change as the joint portion rotates.

The present disclosure has been made in view of the above issue, and a main object of the present disclosure is to provide a joint mechanism capable of suppressing a change in a path length of a linear member even when a joint portion rotates.

One aspect of the present disclosure for achieving the above object provides a joint mechanism including:
a first link and a second link;
a joint portion that rotatably connects the first link and the second link;
a pulley provided on the joint portion; and
a linear member that extends from one end on the first link side to another end on the second link side, the linear member being wound around the pulley halfway through.

A rotation center of the joint portion is offset with respect to a center of the pulley such that a change in a path length of the linear member when the joint portion is extended and bent is reduced.

According to the aspect, when
a distance between the rotation center of the joint portion and the other end of the linear member is set to 1,
a radius of the pulley is set to r,
a distance between a line passing through the center of the pulley, the line being parallel to a line passing through the one end and the other end of the linear member, and the one end of the linear member is set to a, and
a distance between a line passing through the rotation center of the joint portion, the line being perpendicular to the line passing through the one end and the other end of the linear member, and the center of the pulley is set to b,
the rotation center of the joint portion may be offset with respect to the center of the pulley such that a difference value Δ obtained by the following formula is equal to or less than a predetermined value

Difference value Δ=((1−a)²+(r−b)²)^{1/2}+πr/2−((1+b)²+(r−a)²)^{1/2}.

According to the aspect,
the rotation center of the joint portion may be offset with respect to the center of the pulley such that the difference value Δ is zero.

According to the aspect,
the rotation center of the joint portion may be offset with respect to the center of the pulley such that a=b is satisfied.

According to the present disclosure, it is possible to provide a joint mechanism that can suppress the change in the path length of the linear member even when the joint portion rotates.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a simplified diagram showing a schematic configuration of a joint mechanism according to the present embodiment;

FIG. 2 is a diagram showing a relationship between an elbow joint portion and a pulley;

FIG. 3 is a diagram illustrating a method of reducing a change in a path length of a wire when the elbow joint portion is extended and bent;

FIG. 4 is a diagram showing a relationship between b and a radius r of the pulley when a=0 is satisfied; and

FIG. 5 is a diagram showing a relationship between a and the radius r of the pulley when b=0 is satisfied.

### DETAILED DESCRIPTION OF EMBODIMENTS

Hereinafter, the present disclosure will be described through embodiments of the disclosure. However, the disclosure according to the claims is not limited to the following embodiments. Moreover, all of the configurations described in the embodiments are not necessarily indispensable as means for solving the issue.

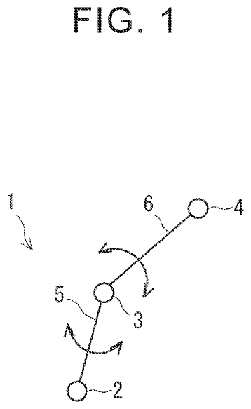

FIG. 1 is a simplified diagram showing a schematic configuration of a joint mechanism according to the present embodiment. The joint mechanism 1 according to the present embodiment is configured as, for example, a joint mechanism for a robot arm. The joint mechanism 1 includes a shoulder joint portion 2, an elbow joint portion 3, a wrist joint portion 4, a first link 5 that connects the shoulder joint portion 2 and the elbow joint portion 3, and a second link 6 that connects the elbow joint portion 3 and the wrist joint portion 4. The elbow joint portion 3 rotatably connects the first link 5 and the second link 6. The elbow joint portion 3 is a specific example of a joint portion.

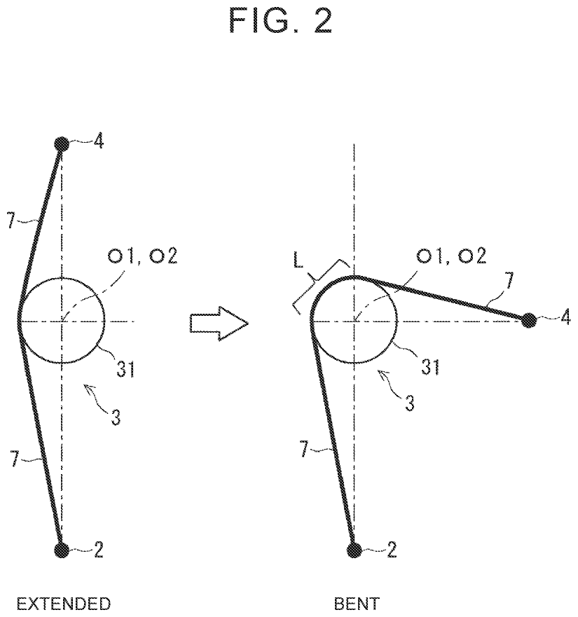

FIG. 2 is a diagram showing a relationship between the elbow joint portion and a pulley. The pulley 31 is provided on the elbow joint portion 3. A wire 7 extends from the shoulder joint portion 2 that is one end on the first link side to the wrist joint portion 4 that is another end on the second link side, and the wire 7 is wound around an outer peripheral surface of the pulley 31 halfway through. The wire 7 is a specific example of a linear member. For example, the wrist joint portion 4 is rotationally driven by pulling the one end side of the wire 7.

Conventionally, as shown in FIG. 2, the rotation center O1 of the elbow joint portion 3 and the center O2 of the pulley 31 coincide with each other. Therefore, when the elbow joint portion 3 rotates and bends, the path length of the wire 7 extends and changes by the L portion. Theoretically, if the diameter of the pulley 31 approaches zero, the change in the path length of the wire 7 can be suppressed. However, in this case, a bend radius is small, and as a result, there arises an issue that the durability of the wire 7 decreases.

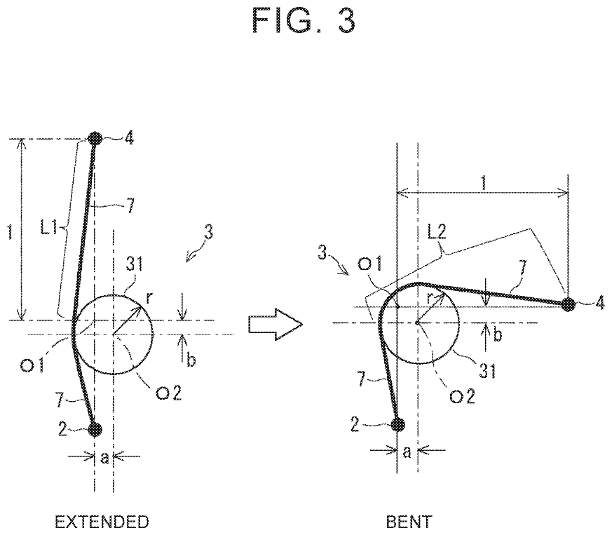

On the other hand, in the joint mechanism 1 according to the present embodiment, as shown in FIG. 3, the rotation center O1 of the elbow joint portion 3 is offset with respect to the center O2 of the pulley 31 such that the change in the path length of the wire 7 when the elbow joint portion 3 is extended and bent is reduced. As a result, the change in the path length of the wire 7 when the elbow joint portion 3 is extended and bent can be reduced. That is, even when the elbow joint portion 3 rotates, the change in the path length of the wire 7 can be suppressed.

FIG. 3 is a diagram illustrating a method of reducing the change in the path length of the wire when the elbow joint portion is extended and bent. The left side in FIG. 3 shows a state in which the elbow joint portion 3 is extended. The right side in FIG. 3 shows a state in which the elbow joint portion 3 is bent. It is assumed that the elbow joint portion 3 moves from an extended state in which a rotation angle is zero degree to a bent state in which the rotation angle is 90 degrees, for example.

As shown in FIG. 3, a difference value Δ that is an amount of change in the path length of the wire 7 when the elbow joint portion 3 is extended and bent can be calculated by Δ=L2−L1.

Here, a distance between the rotation center O1 of the elbow joint portion 3 and the other end (wrist joint portion) 4 of the wire 7 on the second link side is set to 1, and the radius of the pulley 31 is set to r. A distance between a line passing through the center O2 of the pulley 31, the line being parallel to a line passing through the one end (shoulder joint portion) 2 of the wire 7 on the first link side and the other end 4 of the wire 7 on the second link side, and the one end 2 of the wire 7 on the first link side is set to a. A distance between a line passing through the rotation center O1 of the elbow joint portion 3, the line being perpendicular to a line passing through the one end 2 of the wire 7 on the first link side and the other end 4 of the wire 7 on the second link side, and the center O2 of the pulley 31 is set to b.

When parameters are set as described above, the following formulae can be geometrically derived.

L1=((1+b)²+(r−a)²)^{1/2}

L2=(1−a)²+(r−b)²)^{1/2}+πr/2

From the above, the following formula for obtaining the difference value Δ can be derived.

Difference value Δ=L2−L1((1−a)²+(r−b)²)^{1/2}+πr/2−((1+b)²+(r−a)²)^{1/2}

It is preferable to offset the rotation center O1 of the elbow joint portion 3 with respect to the center O2 of the pulley 31 so that the difference value Δ that is the amount of change in the path length of the wire 7 when the elbow joint portion 3 is extended and bent is a small value equal to or less than a predetermined value. Thereby, even when the elbow joint portion 3 rotates, the change in the path length of the wire 7 can be suppressed to a small value equal to or less than the predetermined value. Note that, for example, a value that causes no problem as the amount of change in the path length of the wire 7 is experimentally obtained and set as the predetermined value.

It is most preferable to set the difference value Δ that is the amount of change in the path length of the wire 7 when the elbow joint portion 3 is extended and bent to zero. As a result, even when the elbow joint portion 3 rotates, the change in the path length of the wire 7 can be eliminated.

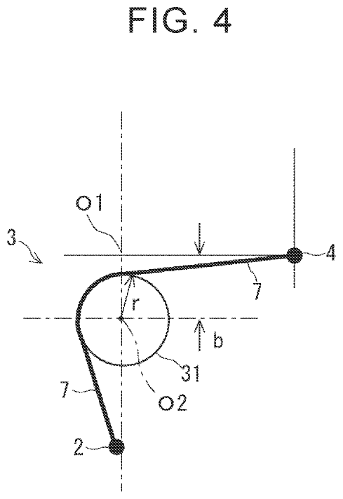

As shown in FIG. 4, a=0 may be satisfied. In this case, b is larger than the radius r of the pulley 31, and the rotation center O1 of the elbow joint portion 3 is positioned outside the pulley 31.

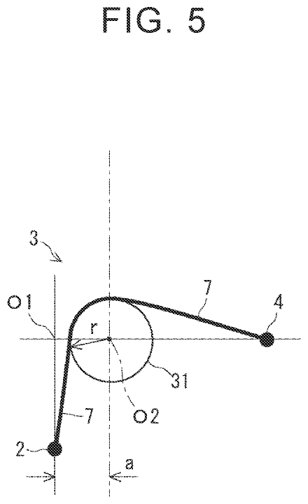

Similarly, as shown in FIG. 5, b=0 may be satisfied. In this case, a is larger than the radius r of the pulley 31, and the rotation center O1 of the elbow joint portion 3 is positioned outside the pulley 31.

The longer the length of the wire 7 that winds around the pulley 31, the greater the sliding resistance of the wire 7. Therefore, it is preferable to offset the rotation center O1 of the elbow joint portion 3 with respect to the center O2 of the pulley 31 so that a=b is satisfied. As a result, the sliding resistance of the wire 7 can be reduced.

As described above, in the joint mechanism 1 according to the present embodiment, the rotation center O1 of the elbow joint portion 3 is offset with respect to the center O2 of the pulley 31 such that the change in the path length of the wire 7 when the elbow joint portion 3 is extended and bent is reduced. As a result, the change in the path length of the wire 7 when the elbow joint portion 3 is extended and bent can be reduced. That is, even when the elbow joint portion 3 rotates, the change in the path length of the wire 7 can be suppressed.

While several embodiments of the disclosure have been described, these embodiments have been presented by way of example and are not intended to limit the scope of the disclosure. These novel embodiments can be embodied in various other modes, and various omissions, replacements, and modifications can be made without departing from the scope of the disclosure. These embodiments and modifications thereof are included in the scope and gist of the disclosure, and are included in the scope of the disclosure described in the claims and equivalents thereof.

In the above embodiment, the present disclosure is applied to the joint mechanism 1 of the robot arm, but not limited to this. For example, the present disclosure may be applied to the joint mechanism of the leg of the robot.

What is claimed is:

1. A joint mechanism comprising:
a first link and a second link;
a joint portion that rotatably connects the first link and the second link;
a pulley provided on the joint portion; and
a linear member that extends from one end on the first link side to another end on the second link side, the linear member being wound around the pulley halfway through, wherein a rotation center of the joint portion is offset with respect to a center of the pulley such that a change in a path length of the linear member when the joint portion is extended and bent is reduced.

2. The joint mechanism according to claim 1, wherein when
a distance between the rotation center of the joint portion and the other end of the linear member is set to 1,
a radius of the pulley is set to r,
a distance between a line passing through the center of the pulley, the line being parallel to a line passing through the one end and the other end of the linear member, and the one end of the linear member is set to a, and
a distance between a line passing through the rotation center of the joint portion, the line being perpendicular to the line passing through the one end and the other end of the linear member, and the center of the pulley is set to b,
the rotation center of the joint portion is offset with respect to the center of the pulley such that a difference value Δ obtained by the following formula is equal to or less than a predetermined value
Difference value Δ=((1−a)²+(r−b)²)^{1/2}+πr/2−((1−b)²+(r−a)²)^{1/2}.

3. The joint mechanism according to claim 2, wherein the rotation center of the joint portion is offset with respect to the center of the pulley such that the difference value Δ is zero.

4. The joint mechanism according to claim 2, wherein the rotation center of the joint portion is offset with respect to the center of the pulley such that a=b is satisfied.
